(19) United States
(12) Patent Application Publication
(10) Pub. No.: US 2011/0228850 A1
(43) Pub. Date: Sep. 22, 2011

(54) METHOD OF PROCESSING A VIDEO SEQUENCE AND ASSOCIATED DEVICE

(75) Inventors: Xavier Henocq, Melesse (FR); Guillaume Laroche, Rennes (FR)

(73) Assignee: CANON KABUSHIKI KAISHA, Tokyo (JP)

(21) Appl. No.: 13/049,781

(22) Filed: Mar. 16, 2011

(30) Foreign Application Priority Data
Mar. 19, 2010 (FR) 1052011

(51) Int. Cl. H04N 7/26

(52) U.S. Cl. 375/240.12; 375/E07.243

(57) ABSTRACT

The invention concerns a method of processing a video sequence and an associated device.

In relation to the sequence, at least one digital image is compressed by temporal prediction from a plurality of reference images resulting from a plurality of different reconstructions of the same image.

The decoding then provides the steps of:
obtaining reconstructions of a first image, that were used as reference images for the temporal prediction of at least one other image in the sequence; and
combining said reconstructions obtained so as to obtain, for at least part of said first image, at least one display value.

### CROSS REFERENCE TO RELATED APPLICATION

This application claims priority to French Patent Application No. 1052011 filed Mar. 19, 2010, which is hereby incorporated by reference in its entirety.

The present invention concerns a method for processing, such as coding or decoding, a video sequence, and an associated device.

Video compression algorithms, such as those standardized by the standardization organizations ITU, ISO, and SMPTE, exploit the spatial and temporal redundancies of the images in order to generate bitstreams of data of smaller size than those video sequences. Such compressions make the transmission and/or the storage of the video sequences more efficient.

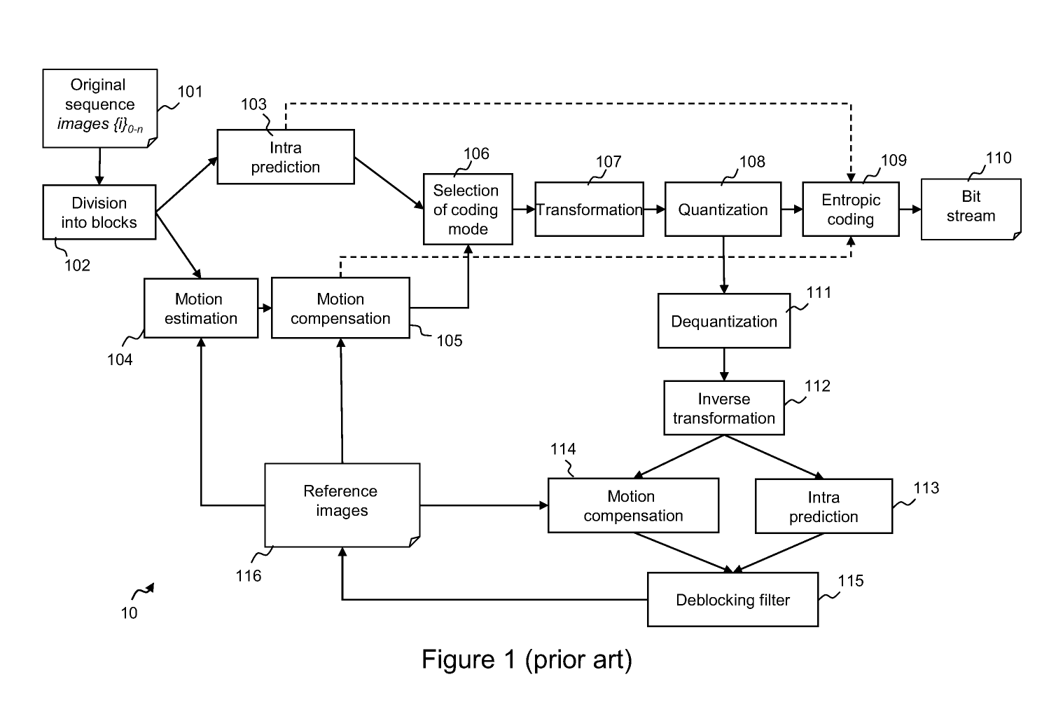

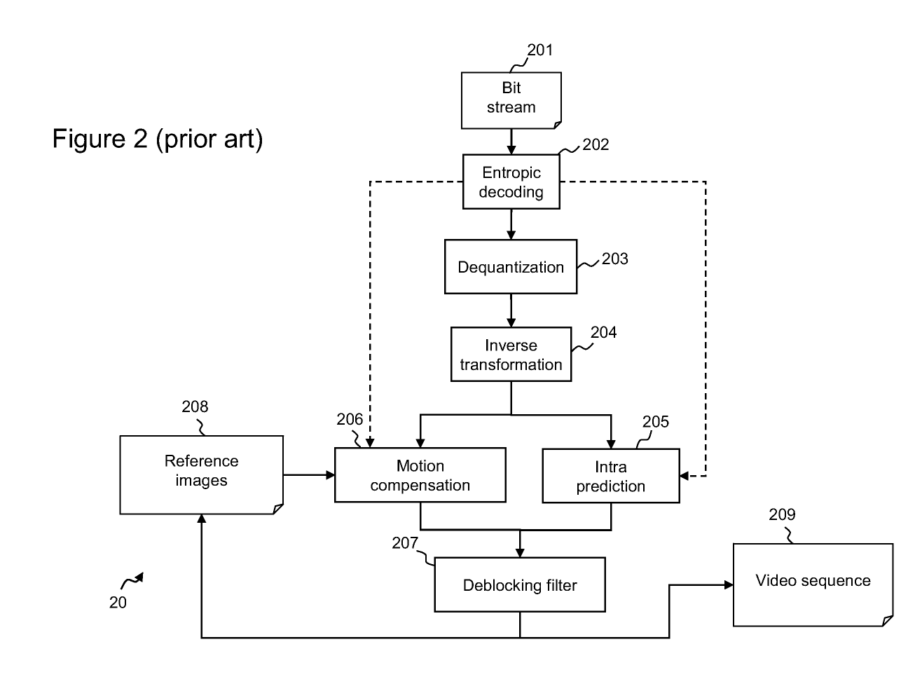

FIGS. 1 and 2 respectively represent the scheme for a conventional video encoder 10 and the scheme for a conventional video decoder 20 in accordance with the video compression standard H.264/MPEG-4 AVC (“Advanced Video Coding”).

The latter is the result of the collaboration between the “Video Coding Expert Group” (VCEG) of the ITU and the “Moving Picture Experts Group” (MPEG) of the ISO, in particular in the form of a publication “Advanced Video Coding for Generic Audiovisual Services” (March 2005).

FIG. 1 schematically represents a scheme for a video encoder 10 of H.264/AVC type or of one of its predecessors.

The original video sequence 101 is a succession of digital images “images i”. As is known per se, a digital image is represented by one or more matrices of which the coefficients represent pixels.

According to the H.264/AVC standard, the images are cut up into “slices”. A “slice” is a part of the image or the whole image. These slices are divided into macroblocks, generally blocks of size 16 pixels×16 pixels, and each macroblock may in turn be divided into different sizes of data blocks 102, for example 4×4, 4×8, 8×4, 8×8, 8×16, 16×8. The macroblock is the coding unit in the H.264 standard.

During video compression, each block of an image during processing is predicted spatially by an “Intra” predictor 103, or temporally by an “Inter” predictor 105. Each predictor is a set of pixels of the same size as the block to be predicted, not necessarily aligned on the grid decomposing the image into blocks, and taken from the same image or another image. From this set of pixels (also hereinafter referred to as “predictor” or “predictor block”) and of the block to be predicted, a differences block (or “residue”) is derived. Identification of the predictor block and coding of the residue make it possible to reduce the quantity of information to be actually encoded.

It should be noted that, in certain cases, the predictor block can be chosen in an interpolated version of the reference image in order to reduce the prediction differences and therefore improve the compression in certain cases.

In the “Intra” prediction module 103, the current block is predicted by means of an “Intra” predictor, a block of pixels constructed from information on the current image already encoded.

With regard to “Inter” coding by temporal prediction, a motion estimation 104 between the current block and reference images 116 (past or future) is performed in order to identify, in one of these reference images, the set of pixels closest to the current block to be used as a predictor of this current block. The reference images used consist of images in the video sequence that have already been coded and then reconstructed (by decoding).

Generally, the motion estimation 104 is a “Block Matching Algorithm” (BMA).

The predictor block identified by this algorithm is next generated and then subtracted from the current data block to be processed so as to obtain a differences block (block residue). This step is called “motion compensation” 105 in the conventional compression algorithms.

These two types of coding thus supply several texture residues (the difference between the current block and the predictor block) that are compared in a module for selecting the best coding mode 106 for the purpose of determining the one that optimizes a rate/distortion criterion.

If “Intra” coding is selected, information for describing the “Intra” predictor is coded (109) before being inserted in the bit stream 110.

If the module for selecting the best coding mode 106 chooses “Inter” coding, motion information is coded (109) and inserted in the bit stream 110. This motion information is in particular composed of a motion vector (indicating the position of the predictor block in the reference image relative to the position of the block to be predicted) and an image index among the reference images.

The residue selected by the choice module 106 is then transformed (107) in the frequency domain, by means of a discrete cosine transform DCT, and then quantized (108). The coefficients of the quantized transformed residue are next coded by means of an entropic or arithmetic coding (109) and then inserted in the compressed bit stream 110 at the useful data coding the blocks of the image.

In the remainder of the document, reference will mainly be made to entropic coding. However, a person skilled in the art is in a position to replace it with arithmetic coding or any other suitable coding.

In order to calculate the “Intra” predictors or to make the motion estimation for the “Inter” predictors, the encoder performs a decoding of the blocks already encoded by means of a so-called “decoding” loop (111, 112, 113, 114, 115, 116) in order to obtain reference images for the future motion estimations. This decoding loop makes it possible to reconstruct the blocks and images from quantized transformed residues.

It guarantees that the coder and decoder use the same reference images.

Thus the quantized transformed residue is dequantized (111) by application of a quantization operation, the inverse to the one provided at step 108, and then reconstructed (112) by application of the transformation that is the inverse of the one at step 107.

If the residue comes from an “Intra” coding 103, the “Intra” predictor used is added to this residue (113) in order to recover a reconstructed block corresponding to the original block modified by the losses resulting from the quantization operation.

If on the other hand the residue comes from an “Inter” coding 105, the block pointed to by the current motion vector (this block belongs to the reference image 116 referred to in the coded motion information) is added to this decoded residue (114). In this way the original block is obtained, modified by the losses resulting from the quantization operations.

In order to attenuate, within the same image, the block effects created by strong quantization of the obtained residues, the encoder includes a “deblocking” filter 115, the objective of which is to eliminate these block effects, in particular the artificial high frequencies introduced at the boundaries between blocks. The deblocking filter 115 smoothes the borders between the blocks in order to visually attenuate these high frequencies created by the coding. Such a filter being known from the art, it will not be described in further detail here.

The filter 115 is thus applied to an image when all the blocks of pixels of this image have been decoded.

The filtered images, also referred to as reconstructed images, are then stored as reference images 116 in order to allow subsequent “Inter” predictions taking place during the compression of the following images in the current video sequence.

In further explanations, the term “conventional” will be given to the information resulting from this decoding loop used in the prior art, that is to say be inversing in particular the quantization and the transformation with conventional parameters. Thus “conventional reconstructed image” or “conventional reconstruction” will now be spoken of.

In the context of the H.264 standard, there exists a multiple reference option for using several reference images 116 for the estimation and motion compensation of the current image, with a maximum of 32 reference images.

In other words, the motion estimation is performed on N images. Thus the best “Inter” predictor of the current block, for the motion compensation, is selected in one of the multiple reference images. Consequently two adjoining blocks can have two predictor blocks that come from two distinct reference images. This is in particular the reason why, in the useful data of the compressed bit stream and at each block of the coded image (in fact the corresponding residue), the index of the reference image (in addition to the motion vector) used for the predictor block is indicated.

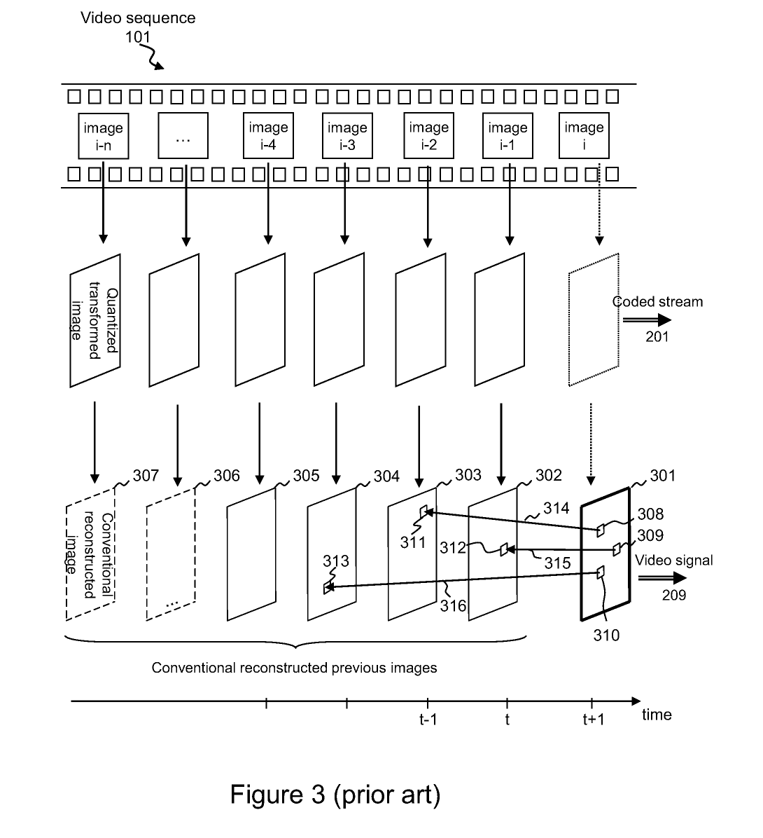

FIG. 3 illustrates this motion compensation by means of a plurality of reference images. In this figure, the image 301 represents the current image during coding corresponding to the image i of the video sequence.

The images 302 and 307 correspond to the images i-1 to i-n that were previously encoded and then decoded (that is to say reconstructed) from the compressed video sequence 110.

In the example illustrated, three reference images 302, 303 and 304 are used in the Inter prediction of blocks of the image 301. To make the graphical representation legible, only a few blocks of the current image 301 have been shown, and no Intra prediction is illustrated here.

In particular, for the block 308, an Inter predictor 311 belonging to the reference image 303 is selected. The blocks 309 and 310 are respectively predicted by the blocks 312 of the reference image 302 and 313 of the reference image 304. For each of these blocks, a motion vector (314, 315, 316) is coded and transmitted with the index (302, 303, 304) of the reference image.

The use of the multiple reference images—the recommendation of the aforementioned VCEG group recommending limiting the number of reference images to four should however be noted—is both a tool for resisting errors and a tool for improving the efficacy of compression.

This is because, with an adapted selection of the reference images for each of the blocks of a current image, it is possible to limit the effect of the loss of a reference image or part of a reference image.

Likewise, if the selection of the best reference image is estimated block by block with a minimum rate-distortion criterion, this use of several reference images makes it possible to obtain significant gains compared with the use of a single reference image.

FIG. 2 shows a global scheme of a video decoder 20 of the H.264/AVC type. The decoder 20 receives as an input a bit stream 201 corresponding to a video sequence 110 compressed by an encoder of the H.264/AVC type, such as the one in FIG. 1.

During the decoding process, the bit stream 201 is first of all decoded entropically (202), which makes it possible to process each coded residue.

The residue of the current block is dequantized (203) using the quantization that is the inverse of that provided at 108, and then reconstructed (204) by means of the transformation that is the inverse of that provided at 107.

Decoding of the data in the video sequence is then performed image by image and, within an image, block by block.

The “Inter” or “Intra” coding mode for the current block is extracted from the bit stream 201 and decoded entropically.

If the coding of the current block is of the “Intra” type, the index of the prediction direction is extracted from the bit stream and decoded entropically. The pixels of the decoded adjacent blocks closest to the current block according to this prediction direction are used for regenerating the “Intra” predictor block.

The residue associated with the current block is recovered from the bit stream 201 and then decoded entropically. Finally, the Intra predictor block recovered is added to the residue thus dequantized and reconstructed in the Intra prediction module (205) in order to obtain the decoded block.

If the coding mode for the current block indicates that this block is of the “Inter” type, then the motion vector, and possibly the identifier of the reference image used, are extracted from the bit stream 201 and decoded (202).

This motion information is used in the motion compensation module 206 in order to determine the “Inter” predictor block contained in the reference images 208 of the decoder 20. In a similar fashion to the encoder, these reference images 208 may be past or future images with respect to the image currently being decoded and are reconstructed from the bit stream (and therefore previously decoded).

The residue associated with the current block is, here also, recovered from the bit stream 201 and then decoded entropically. The Inter predictor block determined is then added to the residue thus dequantized and reconstructed, at the motion compensation module 206, in order to obtain the decoded block.

Naturally the reference images may result from the interpolation of images when the coding has used this same interpolation to improve the precision of prediction.

At the end of the decoding of all the blocks of the current image, the same deblocking filter 207 as the one (115) provided at the encoder is used to eliminate the block effects so as to obtain the reference images 208.

The images thus decoded constitute the output video signal 209 of the decoder, which can then be displayed and used.

These decoding operations are similar to the decoding loop of the coder.

The inventors have however found that the compression gains obtained by virtue of the multiple reference option remain limited. This limitation is rooted in the fact that a great majority (approximately 85%) of the predicted data are predicted from the image closest in time to the current image to be coded, generally the image that precedes it.

In this context, the inventors have envisaged having recourse to several different reconstructions of the same image in the video sequence, for example the image closest in time, so as to obtain several reference images. These different reconstructions can in particular differ over different quantization offset values used during the inverse quantization in the decoding loop.

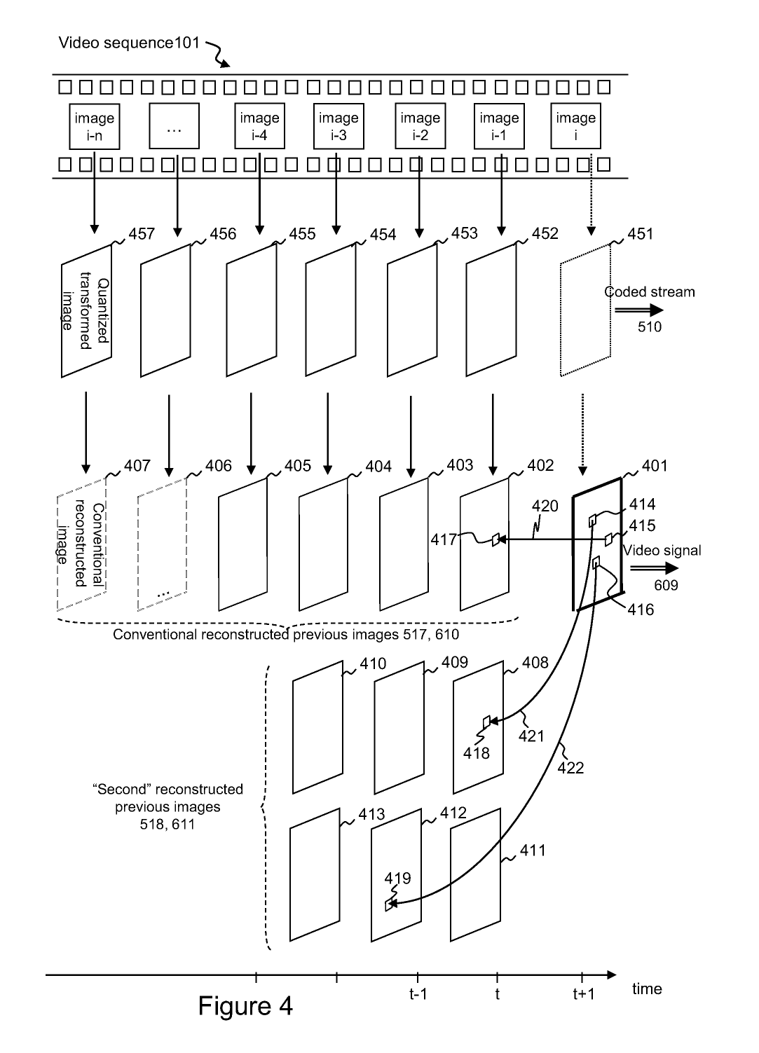

Several parts of the same image can thus be predicted from several reconstructions of the same image, as illustrated in FIG. 4.

This approach makes it possible to obtain predictor blocks closer to the blocks to be coded and therefore to substantially improve the temporal prediction and the rate/distortion compression ratio.

The image displayed at the decoder does however remain the one relating to conventional reconstruction. Compared with the original image, this image has in particular deteriorated because of the transformation and quantization operations during coding.

In this context, the present invention aims to improve the visual quality of the video sequence restored on display during decoding.

For this purpose, the invention concerns in particular a method of processing a video sequence, at least one digital image composing the video sequence being compressed using temporal prediction (or motion compensation) from a plurality of reference images, characterized in that, the temporal prediction using a plurality of different reconstructions of the same image as reference images, the method comprises the steps consisting of:

obtaining reconstructions of a first image that were used as reference images for the temporal prediction of at least one other image in the sequence; and

combining said reconstructions obtained so as to obtain, for at least part (for example a pixel or a block) of said first image, at least one display value.

The present invention thus makes provision for using different reconstructions, normally designed solely to produce multiple reference images, in order to modify the conventional reconstruction normally dedicated to display.

In a decoding context, said first image is the one that must be decoded, the display values obtained allowing a display of this decoded image.

In a coding context, the display value evaluated by the coder is not necessarily displayed at the decoder, but makes it possible, as will be seen subsequently, to impact the display at the decoder.

The invention is based on a finding according to which, as there exist strong temporal correlations between the successive images in the sequence, the predictor blocks, which are moreover the closest to the blocks to be coded, are generally also the closest to the original image from which they are derived (by multiple reconstructions).

The various reconstructions thus make it possible to refine, all the more so as they serve for the prediction of images very close in time (and therefore highly correlated), the values of any pixel possibly modified by the quantization of the coding.

The combination of these reconstructions in the end makes it possible to average, in the block, the error on each pixel caused by the operations with loss (quantization in particular).

In one embodiment of the invention, the digital images are composed of blocks of pixels and the method comprises, for a block in the first image, the steps consisting of:

determining the block or blocks of the at least one other image that are predicted temporally from a reconstruction of at least part of said block of the first image; and

obtaining a display block by combining the reconstructions of at least part of said block of the first image, identified during the determination step.

In this configuration, the correction of the image to be displayed by combination of reconstructions is made at each block, the basic unit of the motion estimation. This approach makes it possible to refine more precisely and locally each part of the image to be displayed, taking account of its contribution particular to the motion estimation of other images.

In particular, the method comprises, if no block is predicted temporally from a reconstruction of at least part of said block of the first image, a step consisting of recovering, in a predefined reconstruction of the image to be decoded, in particular the so-called conventional reconstruction, the block having the same position as said block to be decoded, so as to obtain a display block. This provision ensures minimalistic processing, in accordance with the conventional approaches of visual retrieval and therefore with a quality at least equal to that of the conventional approaches.

According to another particular feature, the step of obtaining a display block comprises, for each pixel in the block, steps consisting of:

determining, from said reconstructions identified during the determination step, those for which said corresponding pixel serves as a reference for a temporal prediction;

combining the reconstructions thus determined in order to obtain a display pixel value.

In this configuration, not all the reconstructions identified during the determination of the temporally predicted blocks are combined, but only those where the pixel is used for at least one temporal prediction.

This is because the predictor blocks do not necessarily correspond to a block defined by subdividing or decomposing of the reference image into blocks. An offset in position between the decomposition grid of the image and the predictor blocks may therefore exist.

The result of this offset is that some pixels in the block to be decoded may be used in a greater or lesser extent during a motion compensation process, compared with the adjoining pixels. The approach adopted here makes it possible to take account of this particularity in order to obtain increased precision in the improvement of the image to be displayed.

In particular, combining the determined reconstructions to obtain a display pixel value comprises, for a pixel in said block, calculating the average of the values of the corresponding pixels (that is to say co-located in the reference image) in said determined reconstructions.

The use of the average of the pixels makes it possible to homogeneously smooth the quantization error introduced into the compressed image. Naturally other approaches may be used, for example modifying the pixel of the conventional reconstruction by means of the mean square error on all the reconstructions determined, or selecting a pixel value from all the pixel values taken in the various reconstructions rather than calculating the average.

According to a particular feature, if no reconstruction for which said corresponding pixel serves as a reference for a temporal prediction is determined, the pixel of said display block takes the value of the pixel with the same position in a predefined reconstruction of said first image, in particular in the conventional reconstruction. Yet again, this provision makes it possible at a minimum and by default to recover the image quality of the traditional techniques.

In one embodiment of the invention, during generation and combination of several reconstructions, said at least one other image is included in a predefined number of images that are subsequent (either in the order of display, or in the order of decoding), in said video sequence, to said first image.

This is because, as the invention requires the analysis of future images to determine whether reconstructions of the image currently being processed have served as a basis for a temporal prediction, a processing delay is introduced. The present provision makes it possible to limit this delay introduced by the invention, in order for example to satisfy memory constraints of the decoder or processing speed constraints.

In particular, said at least one other image is the subsequent image closest in time to said first image. In this case, the delay introduced by the invention is reduced to a minimum. This configuration can advantageously be used for decoders with small resources or for quasi real time applications.

In one embodiment, said processing consists of decoding said first image from a compressed video sequence in order to display it, and the method comprises displaying display values obtained for parts making up said first image to be decoded.

In another embodiment, said processing consists of coding said video sequence as a bit stream, and the method comprises the steps of:

determining which, between said display value obtained and a value co-located with said part in a predefined reference image (for example the so-called “conventional” reconstruction of the image), is the closest to a so-called original value co-located in the original version of said first image; and

associating, in the bit stream, with said at least part of the first image, information dependent on said determination, in order to indicate to a decoder of said bit stream to decode said part either by combination of said reconstructions or by use of the predefined reference image.

The coding method thus defined makes it possible, by virtue of the determination carried out, to avoid a non-relevant combination being able to be applied at the decoder. This guarantees that all the parts of the image displayed are at least of the same quality as when they are obtained by conventional techniques.

This method also makes it possible to reduce the processing operations at the decoder since some combinations will not be implemented.

In one embodiment, determining the closest value comprises the step of comparing an error estimated between said display value obtained and the corresponding original value, with an error estimated between the co-located value in the predefined reference image (517) and said original value. This makes it possible to easily select the reconstruction method (either by combination, or by means of the conventional reference image) that is the most effective, either in terms of image distortion or in terms of rate/distortion ratio of the compression.

According to a particular characteristic, the method comprises a step of indicating, in said bit stream, reconstructions to be combined for decoding said part of the first image.

In particular, the method may comprise a step of selecting and indicating, in said bit stream, a subpart of said reconstructions obtained, said selection being made by estimating, in particular minimizing, the distortion between the part of the first image resulting from the combination of said reconstructions and said part of the first image before coding, that is to say the so-called original values corresponding to this part. These provisions make it possible to reduce further the processing operations at the decoder while guaranteeing an appreciable improvement in the display quality of the video sequence.

Correspondingly, the invention concerns a device for processing (coding or decoding) a video sequence, at least one digital image composing the video sequence being compressed using temporal prediction from a plurality of reference images, characterized in that, the temporal prediction using a plurality of different reconstructions of the same image as reference images, the device comprises:

a means for obtaining reconstructions of a first image that were used as reference images for the temporal prediction of at least one other image in the sequence; and

a combination module able to combine said reconstructions thus obtained so as to obtain, for at least part of said first image, at least one display value.

The processing device has advantages similar to those of the method disclosed above, in particular obtaining a restored video sequence on display that is on average of improved visual quality.

Optionally, the device can comprise means relating to the features of the method disclosed previously.

In particular, the processing device may be of the decoder type, and comprise a processing and display means configured to display said display values obtained for parts making up said first image to be decoded.

In another embodiment, the processing device may be of the coder type and comprise

a means for determining the value, from said display value obtained and a value co-located with said part in a predefined reference image, that is the closest to a so-called original value co-located in the original version of said first image; and

an association means for associating, in a bit stream, with said at least part of the first image, information dependent on said determination, so as to indicate to a decoder of said bit stream to decode said part either by combining said reconstructions or by using the predefined reference image.

The invention also concerns an information storage means, possibly totally or partially removable, able to be read by a computer system, comprising instructions for a computer program adapted to implement a method according to the invention when this program is loaded into and executed by the computer system.

The invention also concerns a computer program able to be read by a microprocessor, comprising portions of software code adapted to implement a method according to the invention, when it is loaded into and executed by the microprocessor.

The information storage means and computer program have features and advantages similar to the methods that they use.

Other particularities and advantages of the invention will also emerge from the following description, illustrated by the accompanying drawings, in which:

FIG. 1 shows the global scheme of a video encoder of the prior art;

FIG. 2 shows the global scheme of a video decoder of the prior art;

FIG. 3 illustrates the principle of the motion compensation of a video coder according to the prior art;

FIG. 4 illustrates the principle of the motion compensation of a coder including, as reference images, multiple reconstructions of at least the same image;

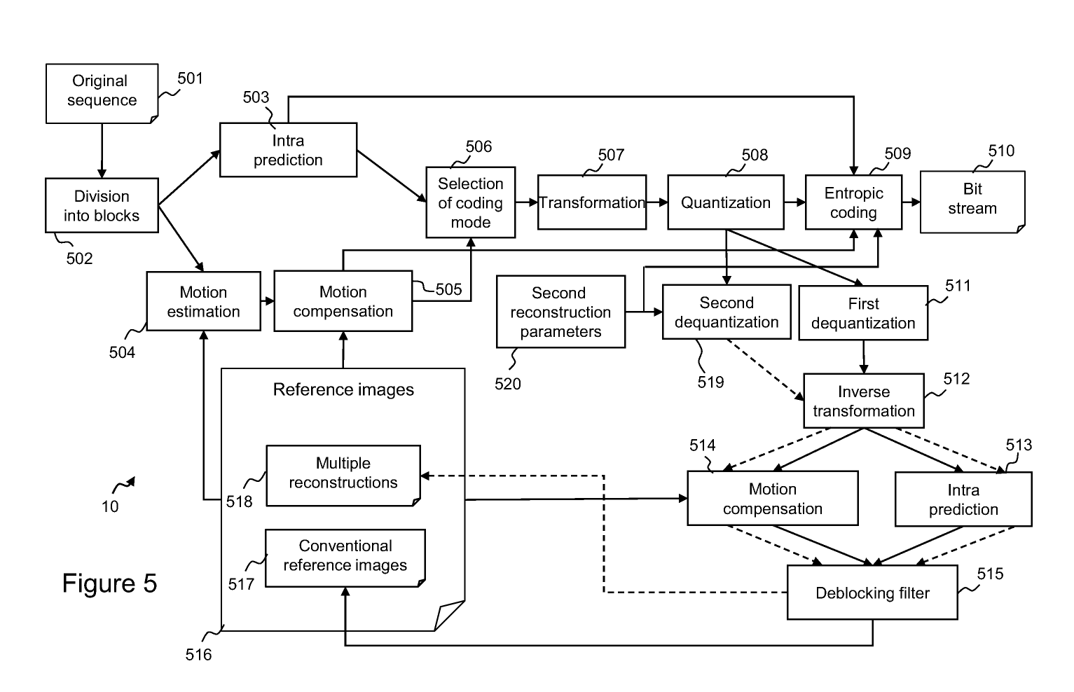

FIG. 5 shows the global scheme of a video encoder using a temporal prediction on the basis of several reference images resulting from several reconstructions of the same image;

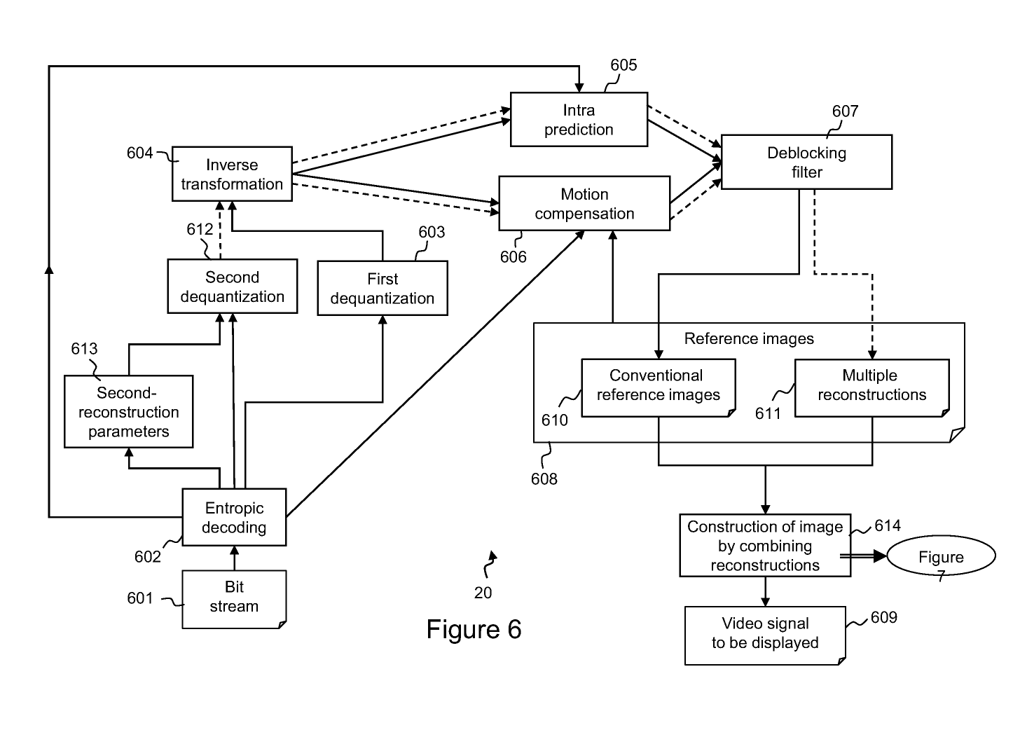

FIG. 6 shows the global scheme of a video decoder according to the invention enabling several reconstructions to be combined to produce an image to be displayed;

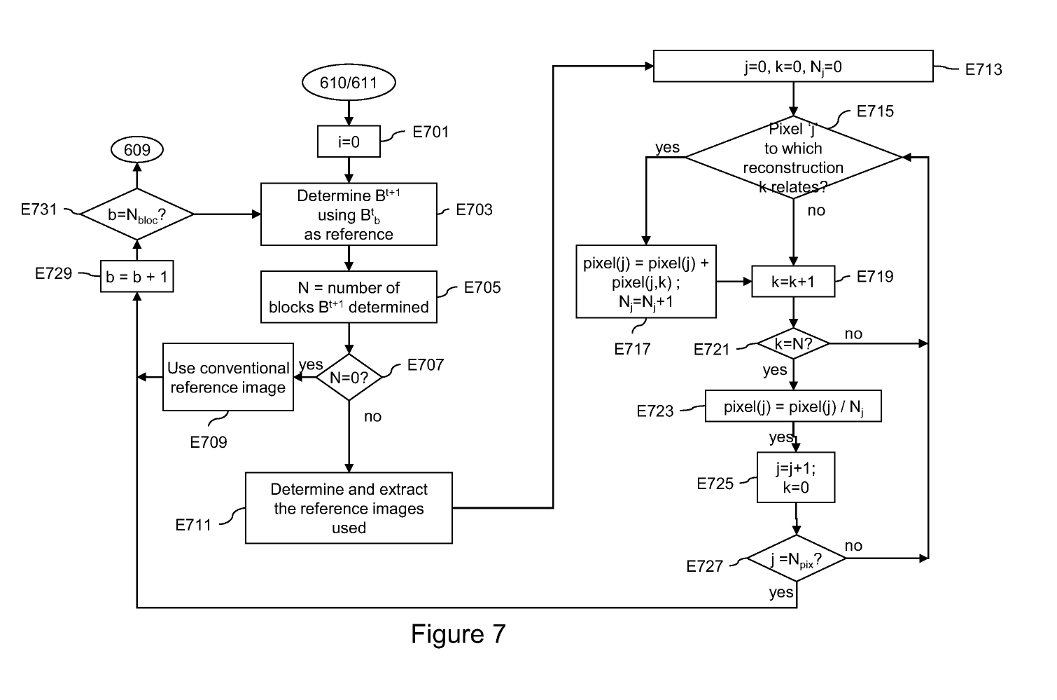

FIG. 7 illustrates, in the form of a logic diagram, post processing steps performed at the combination module of FIG. 6;

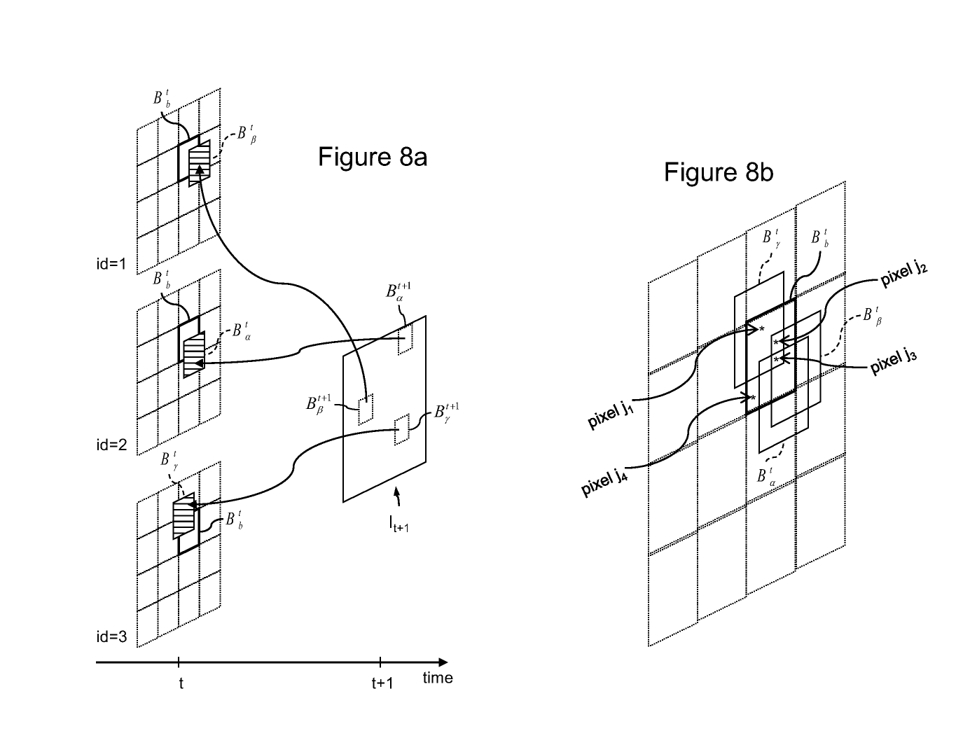

FIGS. 8a and 8b illustrate an example of combination of the pixel values of the various reconstructions, according to the invention; and

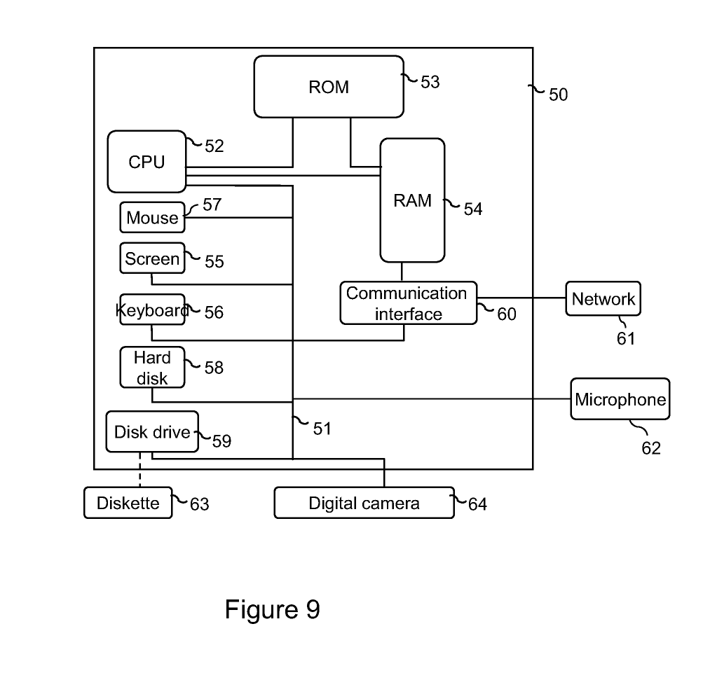

FIG. 9 shows a particular hardware configuration of a device able to implement one or more methods according to the invention.

In the context of the invention, the coding of a video sequence of images comprises the generation of two or more different reconstructions of at least the same image that precedes, in the video sequence, the image to be processed (coded or decoded), so as to obtain at least two reference images for performing a motion compensation or “temporal prediction”.

The processing operations on the video sequence may be of a different nature, including in particular video compression algorithms. In particular the video sequence may be subjected to a coding with a view to transmission or storage.

The remainder of the description will concern more particularly a motion compensation processing applied to an image in the sequence, in the context of a video compression. However, the invention could be applied to other processing operations, for example to the estimation of motions during sequence analysis.

FIG. 4 illustrates motion compensation using several reconstructions of the same reference image, in a representation similar to that of FIG. 3.

The “conventional” reference images 402 to 405, that is to say those obtained according to the prior art, and the new reference images 408 to 413 generated through other reconstructions are shown on an axis perpendicular to the time axis (defining the video sequence 101) in order to show which reconstructions correspond to the same conventional reference image.

More precisely, the conventional reference images 402 to 405 are the images in the video sequence that were previously encoded and then decoded by the decoding loop: these images therefore correspond to those generally displayed by a decoder of the prior art (video signal 209).

The images 408 and 411 result from other decodings of the image 452, also referred to as “second” reconstructions of the image 452. The “second” decodings or reconstructions mean decodings/reconstructions with parameters different from those used for the conventional decoding/reconstruction (according to a standard coding format for example) designed to generate the decoded video signal 209.

As seen subsequently, these different parameters may comprise a DCT block coefficient and a quantization offset θᵢ applied during the reconstruction.

Likewise, the images 409 and 412 are second decodings of the image 453. Finally, the images 410 and 413 are second decodings of the image 454.

In the context of the invention, the blocks of the current image (i, 401) that must be processed (compressed) are each predicted by a block of the previously decoded images 402 to 407 or by a block of a “second” reconstruction 408 to 413 of one of these images 452 to 454.

In this figure, the block 414 of the current image 401 has, as its Inter predictor block, the block 418 of the reference image 408, which is a “second” reconstruction of the image 452. The block 415 of the current image 401 has, as its predictor block, the block 417 of the conventional reference image 402. Finally, the block 416 has, as its predictor, the block 419 of the reference image 413, which is a “second” reconstruction of the image 453.

In general terms, the “second” reconstructions 408 to 413 of an image or of several conventional reference images 402 to 407 can be added to the list of reference images 116, 208, or even replace one or more of these conventional reference images.

It should be noted that, generally, it is more effective to replace the conventional reference images with “second” reconstructions, and to keep a limited number of new reference images (multiple reconstructions), rather than to routinely add these new images to the list. This is because a large number of reference images in the list increases the rate necessary for the coding of an index of these reference images (in order to indicate to the decoder which one to use).

Likewise, it has been possible to observe that the use of multiple “second” reconstructions of the first reference image (the one that is the closest in time to the current image to be processed; generally the image that precedes it) is more effective that the use of multiple reconstructions of a reference image further away in time.

In order to identify the reference images used during encoding, the coder transmits, in addition to the total number and the reference number (or index) of reference images, a first indicator or flag to indicate whether the reference image associated with the reference number is a conventional reconstruction or a “second” reconstruction. If the reference image comes from a “second” reconstruction according to the invention, parameters relating to this second reconstruction, such as the “number of the coefficient” and the “reconstruction offset value” (described subsequently) are transmitted to the decoder, for each of the reference images used.

With reference to FIGS. 5 and 6, a description is now given of a method of coding/decoding a video sequence, using multiple reconstructions of a conventional reference image.

A video encoder 10 according to this embodiment comprises modules 501 to 515 for processing a video sequence with decoding loop, similar to the modules 101 to 115 in FIG. 1.

In particular, according to the standard H.264, the quantization module 108/508 performs a quantization of the residue obtained after transformation 107/507, for example of the DCT type, of the residue of the current pixel block. The quantization is applied to each of the N values of coefficients of this residual block (as many coefficients as there are in the initial pixel block). Calculating a matrix of DCT coefficients and running through the coefficients within the matrix of DCT coefficients are concepts widely known to persons skilled in the art and will not be detailed further here. In particular, the way in which the coefficients are scanned within the blocks, for example a zigzag scan, defines a coefficient number for each block coefficient, for example a continuous coefficient DC and various coefficients of non-zero frequency ACᵢ. For the remainder of the description, “block coefficient”, “coefficient index” and “coefficient number” will be spoken of indifferently to indicate the position of a coefficient within a block according to the scan adopted. “Coefficient value” will also be spoken of to indicate the value taken by a given coefficient in a block.

Thus, if the term Wᵢ is given to the value of the i^{th} coefficient of the residue of the current block (with i varying from 0 to M-1 for a block containing M coefficients, for example W₀=DC and Wᵢ=ACᵢ), the quantized coefficient value Zᵢ , is obtained by the following formula:

$${Z}_{i} = int ( \frac{\vert {W}_{i} \vert + {f}_{i}}{{q}_{i}} ) \cdot sgn ( {W}_{i} )$$

where qᵢ is the quantizer associated to the i^{th} coefficient whose value depends both on a quantization step size denoted QP and the position (that is to say the number or index) of the coefficient value Wᵢ in the transformed block.

To be precise, the quantizer qᵢ comes from a matrix referred to as a quantization matrix of which each element (the values qᵢ) is predetermined. The elements are generally set so as to quantize the high frequencies more strongly.

Furthermore, the function int(x) supplies the integer part of the value x and the function sgn(x) gives the sign of the value x

Lastly, fᵢ is the quantization offset which enables the quantization interval to be centered. If this offset is fixed, it is general equal to

$$\frac{{q}_{i}}{2} .$$

On finishing this step, the quantized residual blocks are obtained for each image, ready to be coded to generate the bitstream 510. In FIG. 4, these images bear the references 451 to 457.

The inverse quantization (or dequantization) process, represented by the module 111/511 in the decoding loop of the encoder 10, provides for the dequantized value W′ᵢ of the i^{th} coefficient to be obtained by the following formula:

W′ᵢ=(qᵢ·|Zᵢ|−θᵢ)·sgn(Zᵢ).

In this formula, Zᵢ is the quantized value of the i^{th} coefficient, calculated with the above quantization equation. θᵢ is the reconstruction offset that makes it possible to center the reconstruction interval. By nature, θᵢ must belong to the interval [−|fᵢ|;|fᵢ|]. To be precise, there is a value of θᵢ belonging to this interval such that W′ᵢ=Wᵢ. This offset is generally set equal to zero.

It should be noted that this formula is also applied by the decoder 20, at the dequantization 203 (603 as described below with reference to FIG. 6).

Still with reference to FIG. 5, box 516 contains the reference images in the same way as box 116 of FIG. 1, that is to say that the images contained in this module are used for the motion estimation 504, the motion compensation 505 on coding a block of pixels of the video sequence, and the motion compensation 514 in the decoding loop for generating the reference images.

The so-called “conventional” reference images 517 have been shown schematically, within the box 516, separately from the reference images 518 obtained by “second” decodings/reconstructions according to the invention.

In particular, the “second” reconstructions of an image are constructed within the decoding loop, as shown by the modules 519 and 520 enabling at least one “second” decoding by dequantization (519) by means of “second” reconstruction parameters (520).

In a variant, however, it would be possible to directly recover the dequantized block coefficients by the conventional method (output of module 511). In this case, at least one corrective residue is determined by applying an inverse quantization of a block of coefficients equal to zero, by means of the required reconstruction parameters (and possible an inverse transformation), and then this corrective residue is added to the conventional reference image (either in its version before inverse transformation, or after filtering 515). In this way the “second” reference image corresponding to the parameters used is obtained.

This variant offers less complexity while keeping identical performance in terms of rate/distortion of the encoded/decoded video sequence.

Returning to the embodiment described with reference to FIG. 5, for each of the blocks of the current image, two dequantization processes (inverse quantization) 511 and 519 are used: the conventional inverse quantization 511 for generating a first reconstruction and the different inverse quantization 519 for generating a “second” reconstruction of the block (and thus of the current image).

It should be noted that, in order to obtain multiple “second” reconstructions of the current reference image, a larger number of modules 519 and 520 may be provided in the encoder 10, each generating a different reconstruction with different parameters as explained below In particular, all the multiple reconstructions can be executed in parallel with the conventional reconstruction by the module 511.

Information on the number of multiple reconstructions and the associated parameters are inserted in the coded stream 510 for the purpose of informing the decoder 20 of the values to use.

The module 519 receives the parameters of a second reconstruction 520 different from the conventional reconstruction. The operation of this module 520 will be described below. The parameters received are for example a coefficient number i of the transformed residue which will be reconstructed differently and the corresponding reconstruction offset θᵢ, as described elsewhere.

These parameters may in particular be determined in advance and be the same for the entire reconstruction (that is to say for all the blocks of pixels) of the corresponding reference image. In this case, these parameters are transmitted only once to the decoder for the image. However, as described below, it is possible to have parameters which vary from one block to another and to transmits those parameters (coefficient number and offset θᵢ) block by block. Still other mechanisms will be referred to below.

These two parameters generated by the module 520 are entropically encoded at module 509 then inserted into the binary stream (510)

In module 519, the inverse quantization for calculating W′ᵢ is applied using the reconstruction offset θᵢ, for the coefficient i, as defined in the parameters 520. In an embodiment, for the other coefficients of the block, the inverse quantization is applied with the conventional reconstruction offset (used in module 511). Thus, in this example, the “second” reconstructions may differ from the conventional reconstruction by the use of a single pair (coefficient, offset).

In particular, if the encoder uses several types of transform or several transform sizes, a coefficient number and a reconstruction offset are transmitted to the decoder for each type or each size of transform.

As will be seen below, it is however possible to apply several reconstruction offsets θᵢ to several coefficients within the same block.

At the end of the second inverse quantization 519, the same processing operations as those applied to the “conventional” signal are performed. In detail, an inverse transformation 512 is applied to that new residue (which has thus been transformed 507, quantized 508, then dequantized 519). Next, depending on the coding of the current block (Intra or Inter), a motion compensation 514 or an Intra prediction 513 is performed.

Lastly, when all the blocks (414, 415, 416) of the current image have been decoded. This new reconstruction of the current image is filtered by the deblocking filter 515 before being inserted among the multiple “second” reconstructions 518.

Thus, in parallel, there are obtained the image decoded via the module 511 constituting the conventional reference image, and one or more “second” reconstructions of the image (via the module 519 and other similar modules the case arising) constituting other reference images corresponding to the same image of the video sequence.

In FIG. 5, the processing according to the invention of the residues transformed, quantized and dequantized by the second inverse quantization 519 is represented by the arrows in dashed lines between the modules 519, 512, 513, 514 and 515.

It will therefore be understood here that, like the illustration in FIG. 4, the coding of a following image may be carried out by block of pixels, with motion compensation with reference to any block from one of the reference images thus reconstructed, “conventional” or “second” reconstruction.

With reference now to FIG. 6, a decoder 20 according to the invention comprises decoding processing modules 601 to 609 equivalent to the modules 201 to 209 described above in relation to FIG. 2, for producing a video signal 609 for the purpose of a reproduction of the video sequence by display. In particular, the dequantization module 603 implements for example the formula W′ᵢ=(qᵢ·|Zᵢ|−θᵢ)·sgn(Zᵢ) disclosed previously.

By way of illustration and for reasons of simplification of representation, the images 451 to 457 (FIG. 4) may be considered as the coded images constituting the bitstream 510 (the entropy coding/decoding not modifying the information of the image). The decoding of these images generates in particular the images making up the output video signal 609.

The reference image module 608 is similar to the module 208 of FIG. 2 and, by analogy with FIG. 5, it is composed of a module for the multiple “second” reconstructions 611 and a module containing the conventional reference images 610. In a variant also, blocks of reconstructions containing corrective residues can be used.

At the start of the decoding of a current image corresponding to an instant “t”, and denoted Iₜ, the number of multiple reconstructions is extracted from the bitstream 601 and decoded entropically. Similarly, the parameters (coefficient number and corresponding offset) of the “second” reconstructions are also extracted from the bitstream, decoded entropically and transmitted to the second reconstruction parameter module or modules 613.

In this example, the process of a single second construction is described, although in the same manner as for the coder 10, other reconstructions may be performed, possibly in parallel, with suitable modules.

Thus a second dequantization module 612 calculates, for each data block of the image Iₜ at instant “t”, an inverse quantization different from the “conventional” module 603.

In this new inverse quantization, for the number of the coefficient given in parameter 613, the dequantization equation is applied with the reconstruction offset θᵢ also supplied by the second reconstruction parameter module 613.

The values of the other coefficients of each residue are, in this embodiment, dequantized with a reconstruction offset similar to the module 603, generally equal to zero.

As for the encoder, the residue (transformed, quantized, dequantized) output from the module 612 is detransformed (604) by application of the transform that is inverse to the one 507 used on coding. In this way a residual value is obtained for each of the pixels of the block.

Next, depending on the coding of the current block (Intra or Inter), a motion compensation 606 or an Intra prediction 605 is performed on the basis of the reference images resulting from the other images already decoded, adding the predictor block identified in the bit stream (through the motion information: reference image index and motion vector) to the residue thus obtained.

Lastly, when all the blocks of the current image have been decoded, the new reconstruction of the current image is filtered by the deblocking filter 607 before being inserted among the multiple “second” reconstructions 611.

This path for the residues transformed, quantized and dequantized by the second inverse quantization 612 is symbolized by the arrows in dashed lines.

Moreover, according to the teachings of the present invention, the decoder also comprises a module 614 for post processing the various reconstructions 610, 611 thus obtained in order to generate the video signal to be displayed 609.

As will be seen subsequently with reference to FIG. 7 explaining the functioning of the post processing module 614, a decoded image to be displayed is generated from the combination of the various reconstructions of this image which were able to serve as reference images for the temporal prediction of other images in the sequence.

As the temporal prediction tends to choose the predictor blocks closest to a block to be coded, this combination of reconstructions makes it possible to attenuate uncertainties introduced by the operations with loss (such as the quantization 508 of the coding).

In a variant embodiment aimed at reducing the calculations and the processing time, it is envisaged reconstructing, as a “second” reconstruction during decoding, only the blocks of the “second” reconstruction actually used for the motion compensation, and therefore useful for generating the images to be displayed. “Actually used” means a block of the “second” reconstruction that constitutes a reference (that is to say a block predictor) for the motion compensation of a block of a subsequently encoded image of the video sequence.

The post processing for generating the decoded images to be displayed is now described with reference to FIG. 7. At this stage, it should be stated that the “conventional” and “second” reconstructions were generated and stored in the memory 608, possible of buffer/temporary memory type. In a variant, these “second” reconstructions may be generated on the fly and by useful block only, when they are necessary.

For reasons of simplification of the explanations, it is henceforth considered that a coded image Iₜ₊₁ corresponding to a time “t+1” uses reference blocks (for the temporal prediction) belonging only to reconstructions of the image Iₜ at time “t”. In other words, the motion compensation is carried out only from the previous image closest in time.

Naturally the invention as described here can apply when reconstructions of several prior images (or even subsequent images) or of a single image Iₜ₋ₙ are used as a reference base for the temporal prediction of the image Iₜ₊₁.

By virtue of the consideration made here, the identification of the reconstructions of the image Iₜ that were able to serve as reference images for subsequent temporal predictions can be entirely carried out during analysis of the image Iₜ₊₁. Thus, in this mode, the invention only introduces a processing delay before display that is equal to an image, making it possible to preserve a “real time” behavior of the decoding.

If the motion compensations are made from reconstructions of several prior images, it is possible to limit the identification analysis as described below to a predefined number Nₘₐₓ of images, so as to limit the processing time introduced before display.

FIG. 7 therefore represents the post processing carried out at time “t+1” in order to generate the image Iₜ to be displayed.

At step E701, a variable b successively identifying the N_{block} blocks B^{t} in the image Iₜ to be generated for the display (scanning the blocks in zigzag for example) is initialized to 0. Hereinafter the block of index b in the image Iₜ is denoted B_{b}^{t}. It should be noted that, for the explanations that will follow, the index b can be omitted when B^{t} designates in general terms a block of the image Iₜ.

At step E703, the blocks B^{t+1} in the image Iₜ₊₁ that use all or part of the block B_{b}^{t} of the image Iₜ to be generated, that is to say where the coding by prediction relies on at least part of the block B_{b}^{t} as a predictor block, are determined. This is because, for the record, the predictor blocks are sets of pixels not necessarily aligned on the grid decomposing the images in blocks B^{t}.

In particular, this step can consist of scanning each block B^{t+1} predicted temporally in the image Iₜ₊₁, and in this case using the motion information (here the motion vector) to identify which blocks B^{t} in the image Iₜ are used for the temporal prediction (the blocks straddling the predictor block used). Then it is determined whether the block B_{b}^{t} is among these blocks B^{t} identified.

It should be noted that subsequently we will consider that all the motion vectors of the image Iₜ₊₁ point to real pixels of the reference image rather than to virtual pixels obtained by sub-pixel interpolation, when the temporal prediction involves an interpolation of the reference images.

In a preferred implementation, if the vectors point to sub-pixel pixels, this will come down to the adjoining real pixels by rounding the motion vector so that it points to the real pixels closest to the virtual pixels. This makes it possible to proceed with the construction of the image to be displayed without necessarily proceeding with the interpolation of the reference images.

At step E705, a variable N is initialized to the value corresponding to the number of blocks B^{t+1} determined at step E703. N therefore represents the number of temporal predictions made from at least a part of the block B_{b}^{t}.

Thus, if N=0, the block B_{b}^{t} to be generated is not used for the temporal prediction of the image Iₜ₊₁ (or of another image, in the general case of the invention). In this case (output “yes” of test E707), this block to be generated is constructed (E709) from the “conventional” reconstruction of the image Iₜ. This “conventional” reconstruction makes it possible to obtain, for this block, a quality at least equivalent to the conventional techniques.

If N≧1, at least a block B^{t+1} of the image Iₜ₊₁ uses at least partially the block B_{b}^{t} as predictor for the motion compensation. In this case (output “no” of test E707), at step E711, the reference images (and therefore the reconstructions of the image Iₜ) that were used for these N temporal predictions are determined and extracted from the memory 608, by means again of the motion information obtained from the bit stream 601 (here the indices of the reference images).

The post-processing then continues with the construction of the block B_{b}^{t} to be generated for the display.

This construction begins at step E713, with the initialization of three variables to 0:

a variable “j” identifying each pixel (identified from 0 to Nₚᵢₓ−1) in the block B_{b}^{t}. j ∈ [0; Nₚᵢₓ] where Nₚᵢₓ is the number of pixels making up a block B^{t};

a variable ‘k’ ∈ [0; N] making it possible to scan each of the N temporal predictions identified at step E703 and indexed from 0 to N−1, and therefore incidentally to scan N reconstructions associated with these N temporal predications (reconstructions among the Ns that can use the same reconstruction parameters {i, θᵢ}); and

a variable Nⱼ identifying, for a given pixel of the block B^{t}, the number of reconstructions, among the N reconstructions identified at step E705, for which the pixel co-located with the given pixel serves as a reference for a temporal prediction.

At this step a table T_{b}^{t}(j)=pixel(j)_{j∈[0, Npix]} is also initialized, in the buffer, to 0, this table being intended to contain in the end the values pixel(j) of the pixels of the block B_{b}^{t} to be displayed.

At step E715, it is checked whether the reconstruction “k” relates to the pixel “j”. In other words, it is determined whether or not the pixel “j” is included in the predictor block used during the temporal prediction “k”.

Yet again, this determination can be carried out by means of the motion vector defining the temporal prediction “k” and the size of the blocks.

In the affirmative at test E715, the value pixel(j,k) of the pixel “j” is added (E717) in the reconstruction “k” to the current value pixel(j) of the pixel “j” of the block B_{b}^{t} to be generated. The result is stored in the entry T_{b}^{t}(j) of the table.

The value of a pixel can in particular correspond to an item of luminance information. In the case where several components are associated with each pixel (for example red-green-blue components or luminance-chrominance components), each of these components can be processed separately.

The variable Nⱼ is then incremented by 1 in order to indicate that an additional reconstruction is taken into account.

If test E715 is negative or following step E717, the variable “k” is incremented in order to analyze the temporal prediction/the following reconstruction.

The value of “k” (test E721) is then tested.

If this is less than N, step E715 is returned to in order to process the following temporal prediction/the reconstruction.

If “k”=N, this means that all the temporal predictions/reconstructions have been analyzed. In this case, the average of the pixel “j” is calculated (E723) for the various reconstructions “k” for which said pixel “j” serves as a reference for a temporal prediction in the image Iₜ₊₁. The value pixel(j) of the pixel “j” calculated iteratively at step E717 is therefore divided by the number Nⱼ of reconstructions that contributed to this value: pixel(j)=pixel(j)/Nⱼ. The result is stored in the entry T_{b}^{t}(j) in the table.

It should be noted that, if a pixel has not served as a basis for a temporal prediction, the values Nⱼ and T_{b}^{t}(j)=pixel(j) at this moment are zero. In this case, step E723 makes the value T_{b}^{t}(j)=pixel(j) take the value of the pixel co-located with “j” in the conventional reconstruction of the image Iₜ. It is thus ensured that at a minimum the same quality of visual rendition can be obtained as the solutions already existing.

Where applicable, a rounding operation is performed (for example if the required display requires only integer values).

In order to proceed with the construction of the following pixel, the variable “j” is then incremented and the variable “k” is reinitialized to 0 (step E725).

The value of “j” is then tested (E727) with the value Nₚᵢₓ in order to check whether all the pixels of the block B_{b}^{t} have been processed.

If not, step E715 is returned to in order to process the following pixel. Otherwise step E729 is passed to.

Also, following step E709, step E729 is passed to, where the value of b is incremented in order to process the following block B_{b}^{t}. This corresponds to moving towards another block of the image Iₜ to be displayed.

At step E731, it is determined whether all the blocks B^{t} of the image Iₜ have been processed. According to circumstances, step E703 is returned to in order to process the following block, or the post processing ends in order to pass to the display of the corrected decoded signal 609 of FIG. 6.

Thus at time “t+1”, the image Iₜ corresponding to time “t”, is displayed, from the values pixel(j) contained in the tables T_{b,b∈[0,N}_{_{bloc}}_{]}^{t}.

In an alternative embodiment, instead of taking, as the value of a pixel “j”, the average of the values of the pixel in the same position in the N different reconstructions involved, it is possible to take one of the values of the pixel having the same position in one of these reconstructions.

For example, it is possible to take the median value among the values pixel(j,k) in all the reconstructions “k” used for a prediction from the pixel having the same position “j”. In this case step E717 consists of storing all the values pixel(j,k), and step E723 consists of selecting the median value.

It should be noted that, if only two values pixel(j,k) are stored, one corresponding to the so-called “conventional” reconstruction and the other corresponding to a so-called “second” reconstruction, one implementation may consist of taking systematically, as value for the pixel “j”, the value pixel(j,k) resulting from this “second” reconstruction.

It should also be noted that the image thus generated for the display is not a “second” reconstruction of the image Iₜ able to be used as a reference image for a subsequent prediction.

In this regard, it is therefore not stored in the memory 608. After display, the buffer storing the tables T_{b,b∈[0,N}_{_{bloc}}_{]}^{t} of pixels can therefore be emptied.

FIGS. 8a and 8b illustrate schematically various configurations for a pixel “j” of the block B_{b}^{t} to be generated for the image Iₜ.

In this example, the analysis E703 makes it possible to identify three blocks B_{α}^{t+1}, B_{β}^{t+1}, et B_{γ}^{t+1} using all or part of the block B_{b}^{t} as part of the predictor block for their associated temporal prediction (FIG. 8a). It will be observed that these predictor blocks are not necessarily aligned on the grid decomposing the image Iₜ into blocks B^{t}.

The block B_{α}^{t+1} uses the predictor block B_{α}^{t} straddling the block B_{b}^{t} in the “second” identified reconstruction “id=2”. The block B_{β}^{t+1} uses the predictor block B_{β}^{t} straddling the block B_{b}^{t} in the identified “conventional” reconstruction “id=1”. And the block B_{γ}^{t+1} uses the predictor block B_{γ}^{t} straddling the block B_{b}^{t} in the “second” reconstruction identified “id=3”.

These various blocks have been superimposed on the image Iₜ to be reconstructed in FIG. 8b.

For a first pixel “j₁” of the block B_{b}^{t}, only one identified temporal prediction uses this pixel as a predictor pixel. This is the temporal prediction γ to which the reconstruction “id=3” corresponds. In the displayed image, the pixel “j₁” then takes the value of the pixel having the same position in the reconstruction “id=3”.

For a second pixel “j₂” in the block B_{b}^{t}, two temporal predictions (β and γ) use this pixel as a predictor pixel. In the image displayed, the pixel “j₂” then takes the average value between the two values of the pixel having the same position in the reconstructions “id=1” and “id=3”.

For a third pixel “j₃” in the block B_{b}^{t}, the three temporal predictions use this pixel as a predictor pixel. In the image displayed, the pixel “j₃” therefore takes the average value between the three values of the pixel having the same position in the three reconstructions

Finally, for another pixel “j₄” of the block B_{b}^{t}, no temporal prediction uses this pixel as a predictor pixel. In the image displayed, the pixel “j₄” then takes the value of the pixel having the same position in the so-called conventional reconstruction (here the one identified “id=1”).

By virtue of this combination of the reconstructions in order to modify the image to be generated for display, the present invention affords an improvement in the quality of the images displayed. An appreciable advantage of this implementation of the invention lies in the fact that no additional information (dedicated solely to this improvement) is necessary.

In another implementation of the invention, the encoder can insert, in the bit stream 510, one or other or even both of the following items of information:

a first item of information indicating whether it is necessary to apply the reconstruction combination method for generating an image to be displayed; and

a second item of information indicating for each pixel of the image Iₜ (or set of pixels) which reconstruction or reconstructions to use for generating the pixel to be displayed.

With regard to the first item of information, it is indicated in the form of a flag with a length of 1 bit, inserted in the bit stream of each block used at least once as a reference in the motion prediction. The encoder then implements the same reference combination method as that described previously for the decoder, and compares the resulting blocks with the blocks obtained by the conventional method.

This comparison consists of determining which of the resulting block and the blocks obtained by the conventional method contains the values closest to the image to be displayed, for example by comparing a distance or error estimated between each of these blocks and the corresponding block (having the same position) in the original image.

If it is determined that the conventional method offers better results for reconstructing the image to be displayed, the value of the flag is set for indicating not to apply the combination. In the contrary case, the value of the flag is set to indicate that it is necessary to apply the combination for the block in question.

One advantage of this implementation is to avoid making a combination when this does not afford any gain in quality and also to reduce the processing at the decoder.

In the case of the use of the second item of information, it is no longer necessary, at the decoder, to use the motion information of Iₜ₊₁, but it is possible to limit oneself to the use solely of the information contained in Iₜ₊₁ and necessary for reconstructing the various reconstructions of Iₜ.

One advantage of this implementation is to ensure, for each pixel (or set of pixels), that the reconstruction is the best, to the detriment however of an additional cost in signaling for transmitting this reconstruction information in the bit stream.

In this case, it is possible in particular for the decoder to determine the best combination of reconstructions to be kept for obtaining the pixel closest to the original pixel. This determination can simply consist of evaluating the value of the pixel for each possible combination of the reconstructions, and to keep the combination supplying the value closest to the original pixel.

In a variant, it would be possible to combine the approach using the motion information described above with this last approach. In this case, advantage is taken of the motion information as long as it makes it possible to obtain rate-distortion performance superior to coding for a set of pixels of the reconstruction information.

The functioning of the module 520 for the optimum selection of coefficients and associated reconstruction offsets is now described. It should be noted however that these selection mechanisms are not the core of the present invention and are described here only by way of examples.

The algorithms described below can in particular be used for selecting parameters of other types for decoding/reconstructing a current image in several “second” reconstructions: for example reconstructions applying a contrast filter and/or a fuzzy filter to the conventional reference image. In this case, the selection may consist of choosing a value for a particular coefficient of a convolution filter used in these filters, or choose the size of this filter.

It should be noted that the module 613 provided on decoding merely recovers information in the bit stream 601.

As introduced previously, one or more pairs of two parameters are used for making a “second” reconstruction of an image denoted “I”: the number i of the coefficient to be dequantized differently and the reconstruction offset θᵢ chosen to perform this different inverse quantization.

The module 520 makes an automatic selection of these parameters for a second reconstruction.

In detail, with regard to the quantization offset, it is considered first of all, to simplify the explanations, that the quantification offset fᵢ of the equation

$${Z}_{i} = int ( \frac{\vert {W}_{i} \vert + {f}_{i}}{{q}_{i}} ) \cdot sgn ( {W}_{i} )$$

above is systematically equal to

$$\frac{{q}_{i}}{2} .$$

By property of the quantization and inverse quantization processes, the optimal reconstruction offset θᵢ belongs to the interval

$$[ - \frac{{q}_{i}}{2} ; \frac{{q}_{i}}{2} ] .$$

As stated above the “conventional” reconstruction for generating the signal 609 generally uses a zero default offset (θᵢ=0). However, another default value may be used.

Several approaches for fixing the offset associated with a given coefficient (the selection of the coefficient is described below), for a “second” reconstruction, can then be provided. Even if it is possible to calculate an optimal offset for each of the (sixteen) block coefficients, provision may be made advantageously to reduce, to a subset, all the block coefficients to be taken into account. In particular, this reduction may consist of selecting the coefficients whose DCT values are the highest on average within the various DC blocks of the image.

Thus, generally, the mean-value DC coefficient, and the first ACⱼ coefficients will be kept.

Once the subset is established, the offset associated with each of the coefficients i of this subset or of the sixteen DCT coefficients is set if the reconstruction of the subset is not used, according to one of the following approaches:

according to a first approach: the choice of θᵢ is fixed according to the number of multiple “second” reconstructions of the current image already inserted in the list 518 of the reference images. This configuration provides reduced complexity for this selection process. This is because it has been possible to observe that, for a given coefficient, the most effective reconstruction offset θᵢ is equal to

$$\frac{{q}_{i}}{4} or - \frac{{q}_{i}}{4}$$

when a single reconstruction of the first image belongs to all the reference images used. When two “second” reconstructions are already available (using

$$\frac{{q}_{i}}{4} and - \frac{{q}_{i}}{4} ) ,$$

an offset equal to

$$\frac{{q}_{i}}{8} or - \frac{{q}_{i}}{8}$$

gives the best mean results in terms of rate/distortion of the signal for the following two “second” reconstructions, etc;

according to a second approach: the offset θᵢ may be selected according to a rate/distortion criterion. If it is wished to add a new “second” reconstruction of the first reference image to all the reference images, then all the values (for example integers) of θᵢ belonging to the interval

$$[ - \frac{{q}_{i}}{2} ; \frac{{q}_{i}}{2} ]$$

are tested; that is to say each reconstruction (with θᵢ different for the given coefficient i) is tested within the coding loop. The quantization offset that is selected for the coding is the one that minimizes the rate/distortion criterion;

according to a third approach: the offset θᵢ that supplies the reconstruction that is most “complementary” to the “conventional” reconstruction (or to all the reconstructions already selected) is selected. For this purpose, the number of times where a block of the evaluated reconstruction (associated with an offset θᵢ, which varies over the range of possible values because of the quantization step size QP) supplies a quality greater than the “conventional” reconstruction block (or than all the reconstructions already selected) is counted, the quality being able to be assessed with a distortion measurement such as an SAD (absolute error—“Sum of Absolute Differences”), SSD (quadratic error—“Sum of Squared Differences”) or PSNR (“Peak Signal to Noise Ratio”). The offset θᵢ that maximizes this number is selected. According to the same approach, it is possible to construct the image each block of which is equal to the block that maximizes the quality among the block with the same position in the reconstruction to be evaluated, that of the “conventional” reconstruction and the other second reconstructions already selected. Each complementary image, corresponding to each offset θᵢ (for the given coefficient), is evaluated with respect to the original image according to a quality criterion similar to those above. The offset θᵢ the image of which constructed in this way maximizes the quality, is then selected.

Next the choice of the coefficient to be modified is passed to. This choice consists of selecting the optimal coefficient among the coefficients of the subset when the latter is constructed, or among the sixteen coefficients of the block.

Several approaches are then envisaged, the best offset θᵢ being already known for each of the coefficients as determined above:

first of all, the coefficient used for the second reconstruction is predetermined. This manner of proceeding gives low complexity. In particular, the first coefficient (coefficient denoted “DC” in the state of the art) is chosen. To be precise, it has been possible to note that the choice of this DC coefficient enables “second” reconstructions to be obtained having the best mean results (in terms of rate-distortion);

in a variant, the reconstruction offset θᵢ being set, determining θᵢ is carried out in similar manner to the second approach above: the best offset for each of the coefficients of the block or of the subset I′ is applied and the coefficient which minimizes the rate-distortion criterion is selected.

in another variant, the coefficient number may be selected in similar manner to the third approach above to determine θᵢ: the best offset is applied for each of the coefficients of the subset I′ or of the block and selection is made the coefficient which maximizes the quality (greatest number of blocks evaluated having a quality better than the “conventional” block).

in still another variant, it is possible to construct the image each block of which is equal to the block that maximizes the quality, among the block with the same position in the reconstruction to be evaluated, those of the “conventional” reconstruction and the other second reconstructions already selected. The coefficient from the block or the subset I′ which maximizes the quality is then selected.

These few examples of approaches enable the module 520 to be provided with pairs (coefficient reference number, reconstruction offset) for piloting the module 519 and performing a corresponding number of “second” reconstructions.

Although the selection of a coefficient i and of its corresponding offset for a “second” reconstruction is mentioned here, mechanisms for obtaining several pairs of parameters that can vary from block to block can be provided, and in particular an arbitrary selection by a user.

With reference now to FIG. 9, a particular hardware configuration of a device for coding or decoding a video sequence able to implement the methods according to the invention is now described by way of example.

A device implementing the invention is for example a microcomputer 50, a workstation, a personal assistant, or a mobile telephone connected to various peripherals. According to yet another embodiment of the invention, the device is in the form of a photographic apparatus provided with a communication interface for allowing connection to a network.

The peripherals connected to the device comprise for example a digital cameral 64, or a scanner or any other image acquisition or storage means, connected to an input/output card (not shown) and supplying to the device according to the invention multimedia data, for example of the video sequence type.

The device 50 comprises a communication bus 51 to which there are connected:

a central processing unit CPU 52 taking for example the form of a microprocessor;

a read only memory 53 in which may be contained the programs whose execution enables the methods according to the invention. It may be a flash memory or EEPROM;

a random access memory 54, which, after powering up of the device 50, contains the executable code of the programs of the invention necessary for the implementation of the invention. As this memory 54 is of random access type (RAM), it provides fast accesses compared to the read only memory 53. This RAM memory 54 stores in particular the various images and the various blocks of pixels as the processing is carried out (transform, quantization, storage of the reference images) on the video sequences;

a screen 55 for displaying data, in particular video and/or serving as a graphical interface with the user, who may thus interact with the programs according to the invention, using a keyboard 56 or any other means such as a pointing device, for example a mouse 57 or an optical stylus;

a hard disk 58 or a storage memory, such as a memory of compact flash type, able to contain the programs of the invention as well as data used or produced on implementation of the invention;

an optional diskette drive 59, or another reader for a removable data carrier, adapted to receive a diskette 63 and to read/write thereon data processed or to process in accordance with the invention; and

a communication interface 60 connected to the telecommunications network 61, the interface 60 being adapted to transmit and receive data.

In the case of audio data, the device 50 is preferably equipped with an input/output card (not shown) which is connected to a microphone 62.

The communication bus 51 permits communication and interoperability between the different elements included in the device 50 or connected to it. The representation of the bus 51 is non-limiting and, in particular, the central processing unit 52 unit may communicate instructions to any element of the device 50 directly or by means of another element of the device 50.

The diskettes 63 can be replaced by any information carrier such as a compact disc (CD-ROM) rewritable or not, a ZIP disk or a memory card. Generally, an information storage means, which can be read by a micro-computer or microprocessor, integrated or not into the device for processing (coding or decoding) a video sequence, and which may possibly be removable, is adapted to store one or more programs whose execution permits the implementation of the methods according to the invention.

The executable code enabling the coding or decoding device to implement the invention may equally well be stored in read only memory 53, on the hard disk 58 or on a removable digital medium such as a diskette 63 as described earlier. According to a variant, the executable code of the programs is received by the intermediary of the telecommunications network 61, via the interface 60, to be stored in one of the storage means of the device 50 (such as the hard disk 58) before being executed.

The central processing unit 52 controls and directs the execution of the instructions or portions of software code of the program or programs of the invention, the instructions or portions of software code being stored in one of the aforementioned storage means. On powering up of the device 50, the program or programs which are stored in a non-volatile memory, for example the hard disk 58 or the read only memory 53, are transferred into the random-access memory 54, which then contains the executable code of the program or programs of the invention, as well as registers for storing the variables and parameters necessary for implementation of the invention.

It will also be noted that the device implementing the invention or incorporating it may be implemented in the form of a programmed apparatus. For example, such a device may then contain the code of the computer program(s) in a fixed form in an application specific integrated circuit (ASIC).

The device described here and, particularly, the central processing unit 52, may implement all or part of the processing operations described in relation with FIGS. 1 to 8, to implement the methods of the present invention and constitute the devices of the present invention.

The above examples are merely embodiments of the invention, which is not limited thereby.

In particular, mechanisms for interpolating the reference images can also be used during motion compensation and estimation operations, in order to improve the quality of the temporal prediction.

Such an interpolation may result from the mechanisms supported by the H.264 standard in order to obtain motion vectors with a precision of less than 1 pixel, for example ½ pixel, ¼ pixel or even ⅛ pixel according to the interpolation used.

1. A method of processing a video sequence, at least one digital image composing the video sequence being compressed using temporal prediction from a plurality of reference images, wherein, the temporal prediction using a plurality of different reconstructions of the same image as reference images, the method comprises the steps consisting of:
obtaining reconstructions of a first image, that were used as reference images for the temporal prediction of at least one other image in the sequence; and
combining said reconstructions obtained so as to obtain, for at least part of said first image, at least one display value.

2. The processing method of claim 1, wherein the digital images are composed of blocks of pixels, and the method comprises, for a block in the first image, the steps consisting of:
determining the block or blocks of the at least one other image that are predicted temporally from a reconstruction of at least part of said block of the first image; and
obtaining a display block by combining the reconstructions of at least part of said block of the first image, identified during the determination step.

3. The processing method of claim 2, comprising, if no block is predicted temporally from a reconstruction of at least part of said block of the first image, a step consisting of recovering, in a predefined reconstruction of the image to be decoded, the block having the same position as said block to be decoded, so as to obtain a display block.

4. The processing method of claim 2, wherein the step of obtaining a display block comprises, for each pixel in the block, steps consisting of:
determining, from said reconstructions identified during the determination step, those for which said corresponding pixel serves as a reference for a temporal prediction;
combining the reconstructions thus determined in order to obtain a display pixel value.

5. The processing method of claim 4, wherein combining the reconstruction determined in order to obtain a display pixel value comprises, for a pixel in said block, calculating the average of the values of the corresponding pixels in said determined reconstructions.

6. The processing method of claim 4, wherein, if no reconstruction for which said pixel serves as a reference for a temporal prediction is determined, the pixel of said display block takes the value of the pixel with the same position in a predefined reconstruction of said first image.

7. The processing method of claim 1, wherein, during generation and combination of several reconstructions, said at least one other image is included in a predefined number of images that are subsequent, in said video sequence, to said first image.

8. The processing method of claim 7, wherein said at least one other image is the subsequent image closest in time to said first image.

9. The processing method of claim 1, wherein said processing consists of decoding said first image from a compressed video sequence in order to display it, and the method comprises displaying display values obtained for parts making up said first image to be decoded.

10. The processing method of claim 1, wherein said processing consists of coding said video sequence as a bit stream, and the method further comprises the steps of:
determining which, between said display value obtained and a value co-located with said part in a predefined reference image, is the closest to a so-called original value co-located in the original version of said first image; and
associating, in the bit stream, with said at least part of the first image, information dependent on said determination, in order to indicate to a decoder of said bit stream to decode said part either by combination of said reconstructions or by use of the predefined reference image.

11. The processing method of claim 10, wherein determining the closest value comprises the step of comparing an error estimated between said display value obtained and the corresponding original value, with an error estimated between the co-located value in the predefined reference image and said original value.

12. The processing method of claim 10, comprising a step of indicating, in said bit stream reconstructions to be combined in order to decode said part of the first image.

13. The processing method of claim 12, also comprising a step of selecting and indicating, in said bit stream, a subpart of said reconstructions obtained, said selection being made by estimating the distortion between said part of the first image resulting from the combination of said reconstructions and said part of the first image before coding.

14. A device for processing a video sequence, at least one digital image composing the video sequence being compressed using temporal prediction from a plurality of reference images, wherein, the temporal prediction using a plurality of different reconstructions of the same image as reference images, the device comprises:
a means for obtaining reconstructions of a first image, that were used as reference images for the temporal prediction of at least one other image in the sequence; and
a combination module able to combine said reconstructions thus obtained so as to obtain, for at least part of said first image, at least one display value.

15. The device of claim 14, of the decoder type, comprising a processing and display means configured to display said display values obtained for parts making up said first image to be decoded.

16. The device of claim 14, of the coder type, comprising:
a means for determining the value, from said display value obtained and a value co-located with said part in a predefined reference image which is the closest to a so-called original value co-located in the original version of said first image; and
an association means for association, in a bit stream, with said at least part of the first image, information dependent on said determination, so as to indicate to a decoder of said bit stream to decode said part either by combining said reconstructions or by using the predefined reference image.

17. An information storage means, possibly totally or partially removable, able to be read by a computer system, comprising instructions for a computer program adapted to implement the method of claim 1 when this program is loaded into and executed by the computer system.

18. A computer program product able to be read by a microprocessor, comprising portions of software code adapted to implement the method of claim 1, when it is loaded into and executed by the microprocessor.
